(19) United States
(12) Patent Application Publication
(10) Pub. No.: US 2008/0181460 A1
(43) Pub. Date: Jul. 31, 2008

(54) IMAGING APPARATUS AND IMAGING METHOD

(76) Inventor: Masaya TAMARU, Asaka-shi (JP)

Correspondence Address: BIRCH STEWART KOLASCH & BIRCH, PO BOX 747, FALLS CHURCH, VA, 22040-0747, US

(21) Appl. No.: 12/022,925

(22) Filed: Jan. 30, 2008

(30) Foreign Application Priority Data
Jan. 31, 2007 (JP) 020706/2007

(51) Int. Cl. G06K 9/00

(52) U.S. Cl. 382/103

(57) ABSTRACT

An imaging apparatus is disclosed. The imaging apparatus includes: an imaging unit for imaging a subject to obtain image data; a display unit for displaying the obtained image data; a subject specifying unit for specifying the subject in the image data; a tracking frame displaying unit for displaying on the display unit a tracking frame surrounding the subject specified by the subject specifying unit; a subject tracking unit for tracking the subject surrounded by the tracking frame displaying unit; an imaging condition controlling unit for controlling an imaging condition for the subject within the tracking frame; and a subject recognizing unit for recognizing whether or not the subject within the tracking frame is the subject specified by the subject specifying unit. The subject recognizing unit repeats the recognition during the tracking by the subject tracking unit.

### BACKGROUND OF THE INVENTION

1. Field of the Invention

The present invention relates to an imaging apparatus such as a digital still camera, and in particular to an imaging apparatus and an imaging method that carry out subject tracking.

2. Description of the Related Art

In recent years, imaging apparatuses, such as digital cameras and digital video cameras, having a subject tracking function for tracking the movement of a specified subject to focus on the subject have been proposed. For example, in an imaging apparatus disclosed in Japanese Unexamined Patent Publication No. 6 (1994)-022195, a subject having the largest area is found from subjects captured within a frame displayed on a screen, and an area value and the color of the subject are detected to specify the subject as the subject having that area value and that color. Then, motion of the specified subject is detected so that the frame follows the detected motion of the subject to carry out AF processing to focus on the specified subject within the frame.

In the above-described imaging apparatus where the area value and the color of the subject are used to specify the subject, however, if there is another subject having the similar area value and the color around the specified subject, such as a case of a sports meet where the user takes images of his or her child from a distance, it is difficult to detect and track his or her child from many children and erroneous detection may occur.

### SUMMARY OF THE INVENTION

In view of the above-described circumstances, the present invention is directed to providing an imaging apparatus and an imaging method that allow reliable tracking of a desired subject.

One aspect of the imaging apparatus of the invention includes: imaging means for imaging a subject to obtain image data; display means for displaying the obtained image data; subject specifying means for specifying the subject in the image data; tracking frame displaying means for displaying on the display means a tracking frame surrounding the subject specified by the subject specifying means; subject tracking means for tracking the subject surrounded by the tracking frame; imaging condition controlling means for controlling an imaging condition for the subject within the tracking frame; and subject recognizing means for recognizing whether or not the subject within the tracking frame is the subject specified by the subject specifying means, wherein the subject recognizing means repeats the recognition during the tracking by the subject tracking means.

The “specifying” herein means specifying a subject intended by the user.

The specification of the subject by the “subject specifying means” may be carried out automatically or manually as long as the subject intended by the user can be specified. For example, in a case where the subject is specified automatically, the face of a child of the user, for example, may be registered in advance, and the face recognizing means may carry out face recognition based on the registered face to specify the recognized face as the subject. Alternatively, the subject may be specified semi-automatically, and in this case, the face of a subject may be automatically detected first, and then the user may check the detected face and specify the face through manipulation of a Do button, for example. In a case where the subject is specified manually, a frame may be displayed on the display means, such as a liquid crystal display screen, and the user may position the frame around a desired subject displayed on the screen. Then, the user may press a Do button, for example, to specify the subject. If the subject is a person, another recognizable object around the face, such as a part of clothes or a cap, may be specified together with the face. By increasing the number of objects specified together with the subject, the rate of erroneous detection can be reduced, thereby improving accuracy of the tracking. The “recognizing” in the invention refers to discriminating an individual (individual person, individual object).

For specifying a subject, a frame may be displayed around the subject when the release button is half-pressed or another button used for the specification is pressed by the user, for example, so that the user can recognize the subject specified on the screen, and if the specified subject is wrong, the user can re-specify the subject soon.

In the imaging apparatus of the invention, the imaging condition may be a setting value of at least one of automatic exposure, automatic focus, automatic white balance and electronic camera shake correction, which is controlled based on the image data of the subject recognized by the subject recognizing means.

The imaging means may carry out actual imaging, based on the imaging condition, of the subject recognized by the subject recognizing means, and the imaging apparatus may further include: image processing means for applying image processing to actual image data obtained through the actual imaging; and at least one of display controlling means for displaying the actual image data subjected to the image processing by the image processing means on the display means and recording means for recording the actual image data subjected to the image processing by the image processing means in an external recording medium or an internal memory.

The image processing may include at least one of gamma correction, sharpness correction, contrast correction and color correction.

The imaging apparatus of the invention may further include imaging instructing means allowing two-step operations thereof including half-pressing and full-pressing; and fixed frame displaying means for displaying on the display means a fixed frame set in advance in a photographic field, wherein the subject specifying means may specify a subject within the fixed frame displayed by the fixed frame displaying means when the imaging instructing means is half-pressed.

The subject tracking means may stop the tracking when the half-pressing of the imaging instructing means is cancelled.

The subject recognizing means may further recognize a feature point around the subject surrounded by the tracking frame.

The imaging apparatus of the invention may further include a subject specification mode for specifying and registering a subject in advance by the subject specifying means, wherein the subject may be specified in two or more pieces of image data obtained by imaging the subject from two or more angles, and the recognition by the subject recognizing means may be carried out based on the two or more pieces of image data.

Another aspect of the imaging apparatus of the invention includes: imaging means for imaging a subject to obtain image data; display means for displaying the obtained image data; subject specifying means for specifying the subject in the image data; tracking frame displaying means for displaying on the display means a tracking frame surrounding the subject specified by the subject specifying means; subject tracking means for tracking the subject surrounded by the tracking frame; imaging condition controlling means for controlling an imaging condition for the subject within the tracking frame; imaging instructing means allowing two-step operations thereof including half-pressing and full-pressing; and fixed frame displaying means for displaying on the display means a fixed frame set in advance in a photographic field, wherein the subject specifying means specifies the subject within the fixed frame displayed by the fixed frame displaying means when the imaging instructing means is half-pressed.

The subject tracking means may stop the tracking when the half-pressing of the imaging instructing means is cancelled.

One aspect of the imaging method of the invention includes: imaging a subject to obtain image data; displaying the obtained image data on display means; specifying the subject in the image data; displaying on the display means a tracking frame surrounding the specified subject; tracking the subject surrounded by the tracking frame; controlling an imaging condition for the subject within the tracking frame; and carrying out imaging based on the controlled imaging condition, wherein whether or not the subject within the tracking frame is the specified subject is repeatedly recognized during the tracking.

Another aspect of the imaging method of the invention includes: imaging a subject to obtain image data; displaying the obtained image data on display means; specifying the subject in the image data; displaying on the display means a tracking frame surrounding the specified subject; tracking the subject surrounded by the tracking frame; repeatedly recognizing during the tracking whether or not the subject within the tracking frame is the specified subject; controlling an imaging condition for the subject within the tracking frame after the recognition; and carrying out imaging based on the controlled imaging condition.

### BRIEF DESCRIPTION OF THE DRAWINGS

FIG. 1 is a view showing the rear side of a digital camera,

FIG. 2 is a view showing the front side of the digital camera,

FIG. 3 is a functional block diagram of the digital camera,

FIGS. 4A and 4B illustrate one example of display on a monitor of the digital camera,

FIGS. 5A and 5B are a flowchart illustrating a series of operations carried out in the digital camera,

FIGS. 6A and 6B illustrate one example of display on a monitor of a digital camera of a second embodiment,

FIGS. 7A and 7B are a flowchart illustrating a series of operations carried out in the digital camera of the second embodiment, and

FIGS. 8A to 8C illustrate one example of display on a monitor of a digital camera of a third embodiment.

### DESCRIPTION OF THE PREFERRED EMBODIMENTS

Hereinafter, an embodiment of an imaging apparatus according to the present invention will be described in detail with reference to the drawings. The following description of the embodiment is given in conjunction with a digital camera, which is an example of the imaging apparatus of the invention. However, the applicable scope of the invention is not limited to digital cameras, and the invention is also applicable to other electronic devices having an electronic imaging function, such as camera-equipped cell-phones and camera-equipped PDAs.

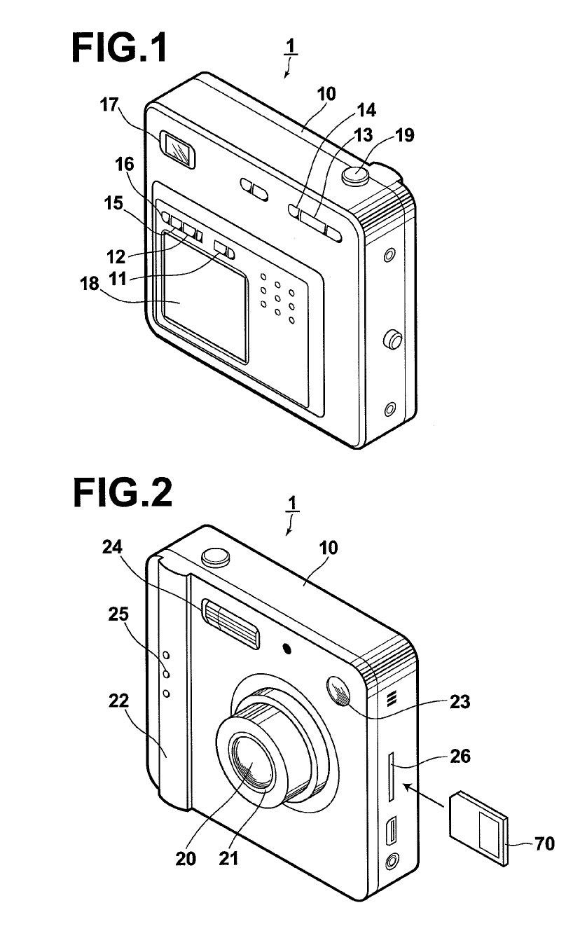

FIGS. 1 and 2 illustrate one example of the appearance of the digital camera viewed from front and rear, respectively. As shown in FIG. 1, the digital camera 1 includes, on the back side of a body 10 thereof, an operation mode switch 11, a menu/OK button 12, a zoom/up-down lever 13, aright-left button 14, a Back (return) button 15 and a display switching button 16, which serve as an interface for manipulation by a photographer, as well as a finder 17 for photographing, a monitor 18 for photographing and playback, and a release button (imaging instructing means) 19.

The operation mode switch 11 is a slide switch for switching between operation modes, i.e., a still image photographing mode, a motion image photographing mode and a playback mode. The menu/OK button 12 is a button to be pressed to display on the monitor 18 various menus in turn, such as a menu for setting a photographing mode, a flash mode, a subject tracking mode and a subject specification mode, ON/OFF of the self-timer, the number of pixels to be recorded, sensitivity, or the like, or to be pressed to make decision on a selection or setting based on the menu displayed on the monitor 18.

The subject tracking mode is a mode used for photographing a moving subject with tracking the subject to photograph the tracked subject under optimal imaging conditions. When this mode is selected, a frame displaying unit 78, which will be described later, is activated, and a fixed frame F1 is displayed on the monitor 18. The fixed frame F1 will be described in detail later.

The zoom/up-down lever 13 is to be tilted up or down to adjust the telephoto/wide-angle position during photographing, or to move a cursor up or down within the menu screen displayed on the monitor 18 during various settings. The right-left button 14 is used to move the cursor right or left within the menu screen displayed on the monitor 18 during various settings.

The Back (return) button 15 is a button to be pressed to terminate a current setting operation and display a previous screen on the monitor 18. The display switching button 16 is a button to be pressed to switch between ON and OFF of the display on the monitor 18, ON and OFF of various guidance displays, ON and OFF of text display, or the like. The finder 17 is used by the user to see and adjust the picture composition and/or the point of focus during photographing a subject. An image of the subject viewed through the finder 17 is captured via a finder window 23 provided on the front side of the body 10 of the digital camera 1.

The release button 19 is a manual operation button that allows the user to make two-step operations including half-pressing and full-pressing. As the user presses the release button 19, a half-pressing signal or a full-pressing signal is outputted to the CPU 75 via a manipulation system controlling unit 74, which will be described later.

Contents of the setting made by the user through manipulation of the above-described buttons and/or the lever can be visually confirmed by the display on the monitor 18, by the lamp in the finder 17, by the position of the slide lever, or the like. The monitor 18 serves as an electronic view finder by displaying a live view for viewing the subject during photographing. The monitor 18 also displays a playback view of photographed still images or motion images, as well as various setting menus. As the user half-presses the release button 19, AE processing and AF processing, which will be described later, are carried out. As the user fully presses the release button 19, photographing is carried out based on data outputted by the AE processing and the AF processing, and the image displayed on the monitor 18 is recorded as a photographed image.

As shown in FIG. 2, the digital camera 1 further includes, on the front side of the body 10 thereof, an imaging lens 20, a lens cover 21, a power switch 22, the finder window 23, a flash light 24 and a self-timer lamp 25. Further, a media slot 26 is provided on a lateral side of the body 10.

The imaging lens 20 focuses an image of the subject on a predetermined imaging surface (such as a CCD provided within the body 10), and is formed, for example, by a focusing lens and a zooming lens. The lens cover 21 covers the surface of the imaging lens 20 when the digital camera 1 is powered off or in the playback mode to protect the imaging lens 20 from dust and other contaminants.

The power switch 22 is used to power on or power off the digital camera 1. The flash light 24 is used to momentarily emit necessary light for photographing toward the subject when the release button 19 is pressed and while the shutter within the body 10 is open. The self-timer lamp 25 serves to inform the subject a timing of opening and closing of the shutter, i.e., the start and the end of exposure, during photographing using a self-timer. The media slot 26 is a port for an external recording medium 70, such as a memory card, to be loaded therein. As the external recording medium 70 is loaded in the media slot 26, writing and reading of data are carried out, as necessary.

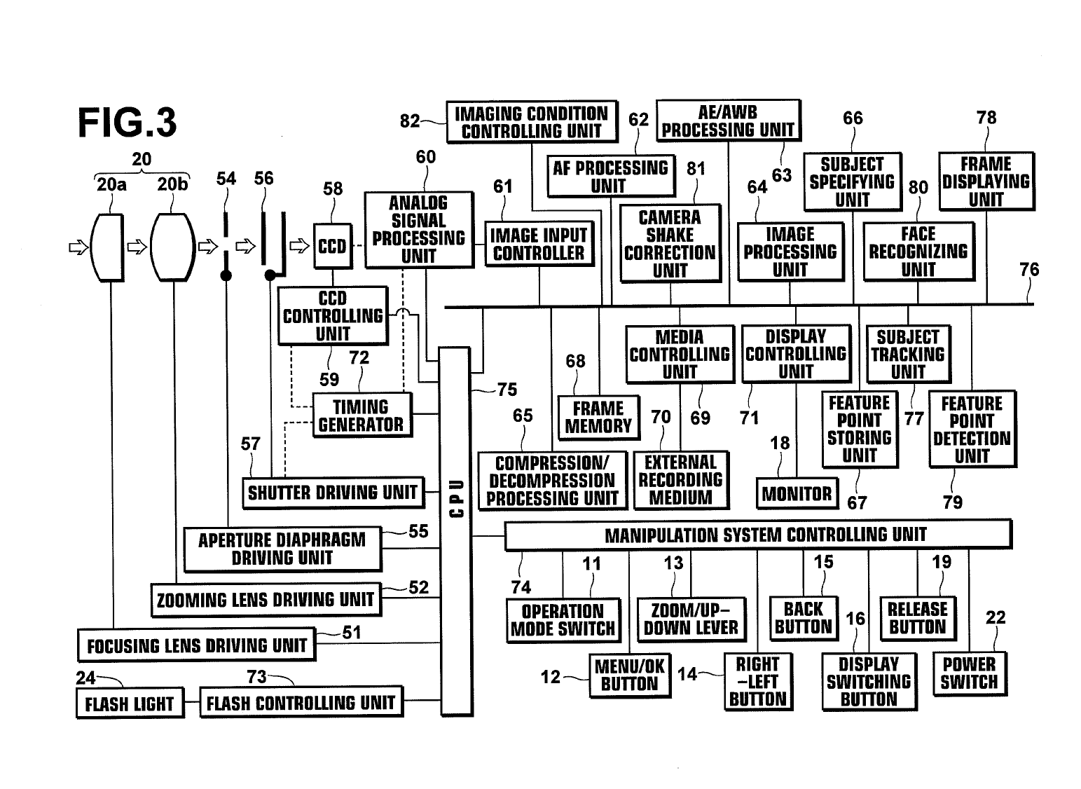

FIG. 3 is a block diagram illustrating the functional configuration of the digital camera 1. As shown in FIG. 3, a manipulation system of the digital camera 1 including the operation mode switch 11, the menu/OK button 12, the zoom/up-down lever 13, the right-left button 14, the Back (return) button 15, the display switching button 16, the shutter button 19 and the power switch 22 described above, and a manipulation system controlling unit 74 serving as an interface between the CPU 75 and manipulation by the user through these switches, buttons and lever, are provided.

Further, a focusing lens 20a and a zooming lens 20b, which form the imaging lens 20, are provided. These lenses can respectively be driven stepwise along the optical axis by a focusing lens driving unit 51 and a zooming lens driving unit 52, each formed by a motor and a motor driver. The focusing lens driving unit 51 drives the focusing lens 20a stepwise based on focusing lens driving amount data outputted from an AF processing unit 62. The zooming lens driving unit 52 controls stepwise driving of the zooming lens 20b based on data representing manipulation amount of the zoom/up-down lever 13.

An aperture diaphragm 54 is driven by an aperture diaphragm driving unit 55, which is formed by a motor and a motor driver. The aperture diaphragm driving unit 55 adjusts the aperture diameter of the aperture diaphragm 54 based on aperture value data outputted from an AE/AWB (automatic white balance) processing unit 63.

The shutter 56 is a mechanical shutter, and is driven by a shutter driving unit 57, which is formed by a motor and a motor driver. The shutter driving unit 57 controls opening and closing of the shutter 56 according to the pressing signal of the release button 19 and shutter speed data outputted from the AE/AWB processing unit 63.

A CCD (imaging means) 58, which is an image pickup device, is disposed downstream the optical system. The CCD 58 includes a photoelectric surface formed by a large number of light receiving elements arranged in a matrix. An image of the subject passing through the optical system is focused on the photoelectric surface and is subjected to photoelectric conversion. A micro lens array (not shown) for converging the light at each pixel and a color filter array (not shown) formed by regularly arrayed R, G and B color filters are disposed upstream the photoelectric surface. The CCD 58 reads electric charges accumulated at the respective pixels line by line and outputs them as an image signal synchronously with a vertical transfer clock signal and a horizontal transfer clock signal supplied from a CCD controlling unit 59. A time for accumulating the charges at the pixels, i.e., an exposure time, is determined by an electronic shutter driving signal supplied from the CCD controlling unit 59.

The image signal outputted from the CCD 58 is inputted to an analog signal processing unit 60. The analog signal processing unit 60 includes a correlation double sampling circuit (CDS) for removing noise from the image signal, an automatic gain controller (AGC) for controlling a gain of the image signal, and an A/D converter (ADC) for converting the image signal into a digital signal data. The digital signal data is CCD-RAW data, which includes R, G and B density values for each pixel.

The timing generator 72 generates timing signals. The timing signals are inputted to the shutter driving unit 57, the CCD controlling unit 59 and the analog signal processing unit 60, thereby synchronizing the manipulation of the release button 19 with opening/closing of the shutter 56, transfer of the electric charges of the CCD 58 and processing by the analog signal processing unit 60. The flash controlling unit 73 controls emission of the flash light 24.

An image input controller 61 writes the CCD-RAW data inputted from the analog signal processing unit 60 in a frame memory 68. The frame memory 68 provides a workspace for various digital image processing (signal processing) applied to the image data, which will be described later. The frame memory 68 is formed, for example, by a SDRAM (Synchronous Dynamic Random Access Memory) that transfers data synchronously with a bus clock signal of a constant frequency.

A display controlling unit (display controlling means) 71 causes the image data stored in the frame memory 68 to be displayed on the monitor 18 as a live view. The display controlling unit 71 converts the image data into a composite signal by combining the luminance (Y) signal and the chromatic (C) signals together and outputs the composite signal to the monitor 18. The live view is taken at predetermined time intervals and is displayed on the monitor 18 while the photographing mode is selected. The display controlling unit 71 also causes an image, which is based on the image data contained in the image file stored in the external recording medium 70 and read out by the media controlling unit 69, to be displayed on the monitor 18.

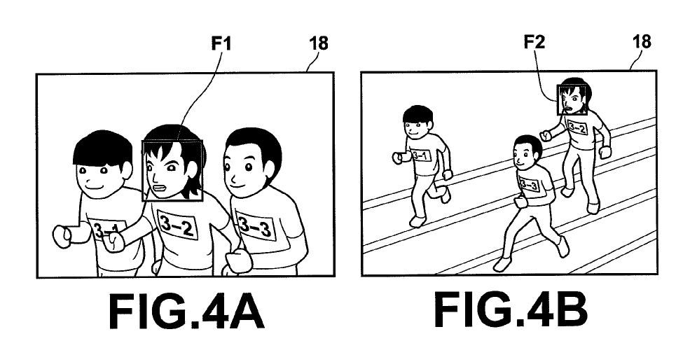

The frame displaying unit (fixed frame displaying means, tracking frame displaying means) 78 displays a frame having a predetermined size on the monitor 18 via the display controlling unit 71. One example of display on the monitor 18 is shown in FIGS. 4A and 4B. The frame displaying unit 78 displays a fixed frame F1 which is fixed at substantially the center of the monitor 18, as shown in FIG. 4A, and a tracking frame F2 which surrounds a subject specified via a subject specifying unit 66 (described later), as shown in FIG. 4B. The tracking frame F2 follows the movement of the specified subject on the screen. When a specified person, for example, moves away, the size of frame may be reduced to fit the size of the face of the specified person, and when the specified person moves closer, the size of the frame may be increased. The distance from the camera to the face of the person may be detected, for example, by using a distance measuring sensor (not shown), or may be calculated based on a distance between right and left eyes of the person, which is calculated from positions of the eyes detected by a feature point detection unit 79.

The feature point detection unit 79 detects a feature point from a subject image within the fixed frame F1 or the tracking frame F2. If the subject within the fixed frame F1 or the tracking frame F2 is a person, positions of the eyes, for example, may be detected as the feature point of the face. It should be noted that the “feature point” has different characteristics for different individuals (individual person, individual object). A feature point storing unit 67 stores the feature point detected by the feature point detection unit 79.

The subject specifying unit (subject specifying means) 66 specifies a subject intended by the user from the subject image displayed on the monitor 18 or within the view through the finder 17, i.e., among objects within a photographic field. The subject is specified manually by the user by adjusting the angle of view so that a desired subject (the face of a person in this embodiment) is captured within the fixed frame F1 displayed on the monitor 18, as shown in FIG. 4A, and half-pressing the release button 19.

The specification of the subject by the subject specifying unit 66 is regarded as successful if the feature point detected by the feature point detection unit 79 from the subject within the fixed frame F1 is accurate enough for a face recognizing unit 80 (described later) to carry out matching.

A subject tracking unit (subject tracking means) 77 tracks the subject surrounded by the tracking frame F2 displayed by the frame displaying unit 78, i.e., the person's face within the tracking frame F2 in this embodiment. The position of the face within the tracking frame F2 is always tracked, and the tracking of the face may be carried out using known techniques such as motion vector and feature point detection, and a specific example of the feature point detection is described in Tomasi, Kanade, “Shape and Motion from Image Streams: a Factorization Method Part 3, Detection and Tracking of Point Features”, Technical Report CMU-CS-91-132 (1991).

The face recognizing unit (subject recognizing means) 80 recognizes the face by matching the feature point detected by the feature point detection unit 79 against the feature point stored in the feature point storing unit 67. The face recognition by the face recognizing unit 80 may be carried out using a technique described in Japanese Unexamined Patent Publication No. 2005-084979, for example.

The AF processing unit 62 and the AE/AWB processing unit 63 determine an imaging condition based on preliminary images. The preliminary images are images based on image data, which is stored in the frame memory 68 when the CPU 75, upon detecting the half-pressing signal generated when the release button 19 is half-pressed, causes the CCD 58 to carry out preliminary photographing.

The AF processing unit 62 detects the focal position on the subject within the fixed frame F1 or the tracking frame F2 displayed by the frame displaying unit 78, and outputs the focusing lens driving amount data (AF processing). In this embodiment, a passive method is used for detecting the focused focal point. The passive method utilizes the fact that a focused image has a higher focus evaluation value (contrast value) than unfocused images. Alternatively, an active method which uses a result of distance measurement by a distance measuring sensor (not shown) may be used.

The AE/AWB processing unit 63 measures a brightness of the subject within the fixed frame F1 or the tracking frame F2 displayed by the frame displaying unit 78, and then determines the aperture value, the shutter speed, and the like, based on the measured brightness of the subject, outputs the determined aperture value data and shutter speed data (AE processing), and automatically adjusts the white balance during photographing (AWB processing).

An image processing unit (image processing means) 64 applies, to the image data of the actually photographed image, image quality correction processing, such as gamma correction, sharpness correction, contrast correction and color correction, and YC processing to convert the CCD-RAW data into YC data formed by Y data representing a luminance signal, Cb data representing a blue color-difference signal and Cr data representing a red color-difference signal. The actually photographed image is an image based on image data of an image signal which is outputted from the CCD 58 when the release button 19 is fully pressed and is stored in the frame memory 68 via the analog signal processing unit 60 and the image input controller 61.

The upper limit for the number of pixels forming the actually photographed image is determined by the number of pixels of the CCD 58. The number of pixels of an image to be recorded can be changed according to image quality setting by the user, such as fine or normal. The number of pixels forming the live view or the preliminary image may be smaller than that of the actually photographed image and may be, for example, about 1/16 of the number of pixels forming the actually photographed image.

A camera shake correction unit 81 automatically corrects blur of a photographed image due to camera shake during photographing. The correction is achieved by translating the imaging lens 20 and the CCD 58, i.e., a photographic field, within a plane that is perpendicular to the optical axis, in a direction in which a fluctuation of the fixed frame F1 or the tracking frame F2 decreases.

An imaging condition controlling unit (imaging condition controlling means) 82 controls a setting value of at least one of the automatic exposure setting by the AF processing unit 62, the automatic focus and/or the white balance setting by the AE/AWB processing unit 63 and the electronic camera shake correction by the camera shake correction unit 81 so that optimal imaging conditions are always provided for the subject within the fixed frame F1 or the tracking frame F2. It should be noted that the imaging condition controlling unit 82 may be implemented as a part of the function of the CPU 75.

A compression/decompression processing unit 65 applies compression processing according to a certain compression format, such as JPEG, to the image data that has been subjected to the image quality correction and the YC processing by the image processing unit 64, to generate an image file. To the image file, accompanying information is added based on corresponding one of various data formats. In the playback mode, the compression/decompression processing unit 65 reads out the compressed image file from the external recording medium 70, and applies decompression processing to the image file. The decompressed image data is outputted to the display controlling unit 71, and the display controlling unit 71 displays an image based on the image data on the monitor 18.

The media controlling unit (recording means) 69 corresponds to the media slot 26 shown in FIG. 2. The media controlling unit 69 reads out an image file stored in the external recording medium 70 or writes an image file in the external recording medium 70. The CPU 75 controls the individual parts of the body of the digital camera 1 according to manipulation of the various buttons, levers and switches by the user and signals supplied from the respective functional blocks. The CPU 75 also functions as recording means for recording an image file in an internal memory (not shown).

The data bus 76 is connected to the image input controller 61, the various processing units 62 to 65 and 83, the subject specifying unit 66, the feature point storing unit 67, the frame memory 68, the various controlling units 69, 71 and 82, the subject tracking unit 77, the frame displaying unit 78, the feature point detection unit 79, the face recognizing unit 80 and the CPU 75, so that transmission of various signals and data is carried out via the data bus 76.

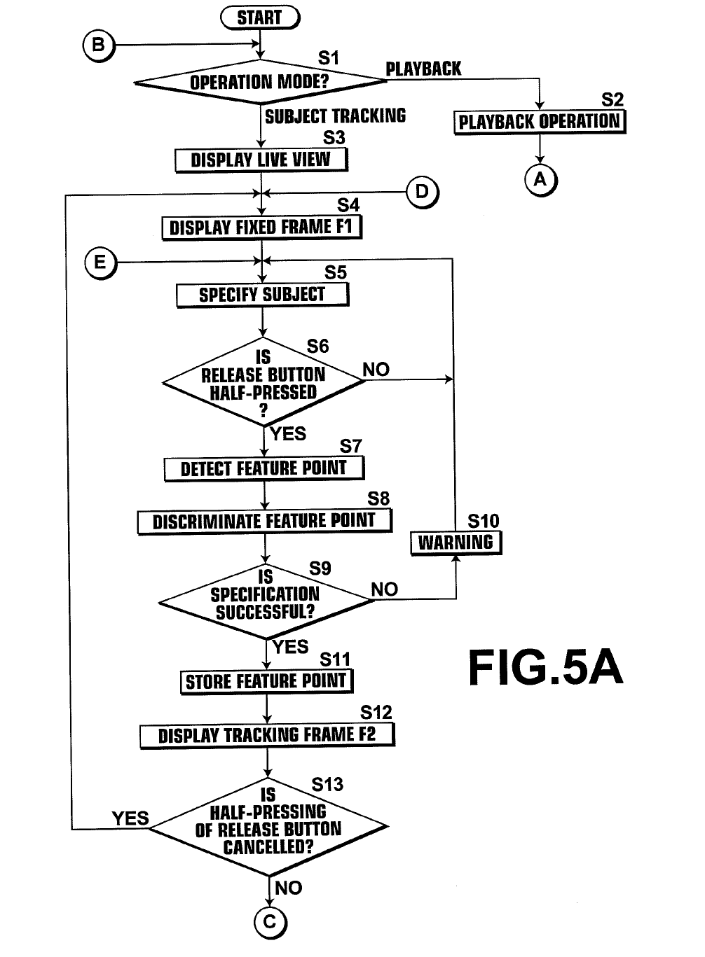

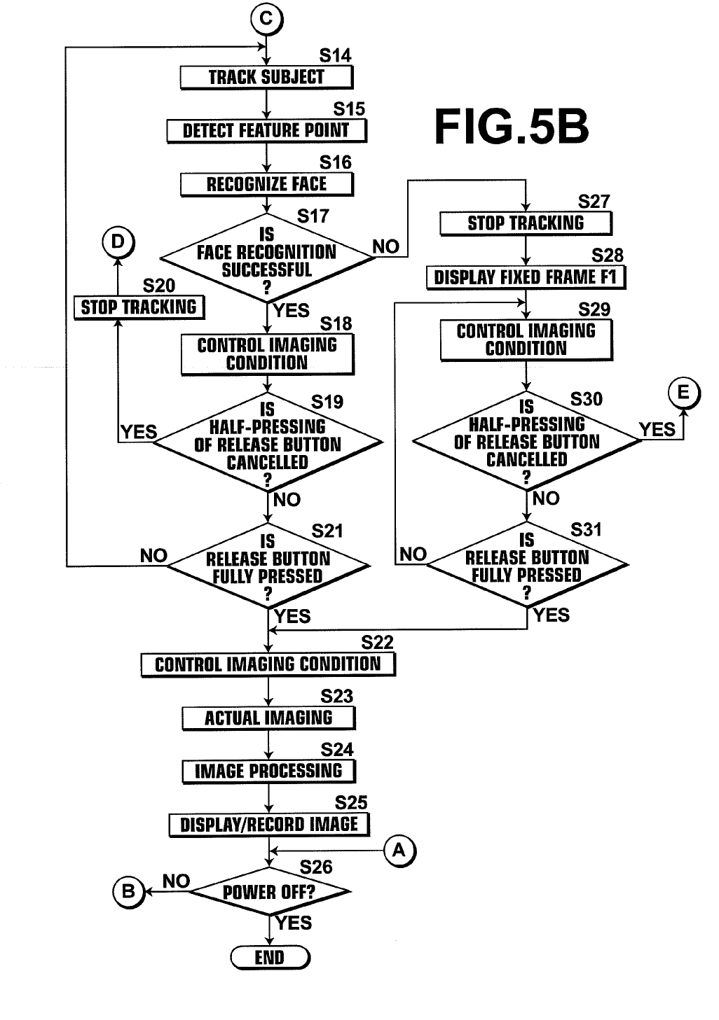

Now, a process carried out during photographing in the digital camera 1 having the above-described configuration will be described. FIGS. 5A and 5B are a flowchart of a series of operations carried out in the digital camera 1. First, as shown in FIG. 5A, the CPU 75 determines whether the operation mode is the subject tracking mode or the playback mode according to the setting of the operation mode switch 11 (step S1). If the operation mode is the playback mode (step S1; playback), a playback operation is carried out (step S2). In the playback operation, the media controlling unit 69 retrieves an image file stored in the external recording medium 70 and displays an image based on image data contained in the image file on the monitor 18. As shown in FIG. 5B, when the playback operation has been finished, the CPU 75 determines whether or not the power switch 22 of the digital camera 1 is turned off (step S26). If the power switch 22 has been turned off (step S26; YES), the digital camera 1 is powered off and the process ends. If the power switch 22 is not turned off (step S26; NO), the process proceeds to step S1, as shown in FIG. 5A.

In contrast, if it is determined in step S1 that the operation mode is the subject tracking mode (step S1; subject tracking), the display controlling unit 71 exerts control to display the live view (step S3). The display of live view is achieved by displaying on the monitor 18 image data stored in the frame memory 68. Then, the frame displaying unit 78 displays the fixed frame F1 on the monitor 18 (step S4), as shown in FIG. 4A.

As the fixed frame F1 is displayed on the monitor 18 (step S4), the user adjusts the angle of view to capture the face of a desired person in the fixed frame F1, as shown in FIG. 4A, and half-presses the release button 19 to specify the intended subject (step S5). By specifying the subject when the release button 19 is half-pressed in this manner, the same manual operation button can be used for specifying the subject and for instructing photographing (full-pressing operation of the release button 19). Thus, the user can make smooth and quick operation to specify the subject and instruct photographing in a hasty photographing situation to release the shutter at the right moment.

Then, the CPU 75 determines whether or not the release button 19 is half-pressed (step S6), and if the release button 19 is not half-pressed (step S6; NO), this means that the user does not specify an intended subject, and the CPU 75 moves the process to step S5 to repeat the operations in step S5 and the following step until the user half-presses the release button 19 to specify an intended subject.

In contrast, if it is determined in step S6 that the release button 19 is half-pressed (step S6; YES), the CPU 75 judges that an intended subject, i.e., the face of a desired person is specified, and the feature point detection unit 79 detects a feature point, such as positions of the eyes, from the specified face within the fixed frame F1 (step S7).

Subsequently, the CPU 75 determines whether or not the detected feature point is accurate enough for the matching by the face recognizing unit 80 (step S8). If the accuracy is not enough, the specification of the subject is determined to be unsuccessful (step S9; NO), and the user is informed to that effect by, for example, a warning beep or a warning display on the monitor 18 (step S10). Then, the CPU 75 moves the process to step S5, and wait until the user specifies a subject again.

In contrast, if the specification of the subject is determined to be successful in step S9 (step S9; YES), the CPU 75 stores the detected feature point in the feature point storing unit 67 (step S11), and the frame displaying unit 78 displays the tracking frame F2 surrounding the face of the specified person (step S12). When the tracking frame F2 is displayed on the monitor 18, the fixed frame F1 displayed on the monitor 18 is hidden by the frame displaying unit 78. It should be noted that the fixed frame F1 may be continuously used to function as the tracking frame F2.

Then, the CPU 75 determines whether or not the half-pressing of the release button 19 is cancelled (step S13). If it is determined that the half-pressing of the release button 19 is cancelled (step S13; YES), it is judged that the user specified a wrong subject, and the CPU 75 moves the process to step S4 to display the fixed frame F1 on the monitor 18 and waits until the user specifies a subject again. By displaying the tracking frame F2 surrounding the specified subject on the monitor 18 in this manner after a successful specification of the subject, the user can recognize the actually specified subject, and if the user has specified a wrong subject, the user can readily re-specify a subject after cancelling the half-pressing of the release button 19 as described above, for example.

In contrast, if the CPU 75 determines in step S13 that the half-pressing of the release button 19 is not cancelled (step S13; NO), then, the subject tracking unit 77 begins tracking of the face of the person surrounded by the tracking frame F2 (step S14), as shown in FIGS. 5B and 4B. During the tracking of the face by the subject tracking unit 77, the feature point detection unit 79 detects the feature point, such as the positions of the eyes, of the person's face being tracked within the tracking frame F2 at predetermined intervals (step S15), and the face recognizing unit 80 matches the detected feature point against the feature point stored in the feature point storing unit 67 to determine whether or not the person within the tracking frame F2 is the person specified in step S5 to recognize the face (step S16).

If the face recognition is successful and the person within the tracking frame F2 is recognized as the specified person (step S17; YES), the imaging condition controlling unit 82 controls imaging conditions to provide optimal imaging conditions for the subject within the tracking frame F (step S18). Then, the CPU 75 determines whether or not the half-pressing of the release button 19 is cancelled (step S19). If it is determined that the half-pressing of the release button 19 is cancelled (step S19; YES), it is judged that the user is not satisfied with the current tracking state, and the subject tracking unit 77 stops the tracking of the person (step S20). Then, the CPU 75 moves the process to step S4 as shown in FIG. 5A, and waits until the next subject is specified. By stopping the tracking of a person when the half-pressing of the release button 19 is cancelled in this manner, the same manual operation button can be used for specifying the subject (half-pressing operation of the release button 19) and for stopping the tracking, so that the user can smoothly and quickly specify the next subject.

In contrast, as shown in FIG. 5B, if the CPU 75 determines in step S19 that the half-pressing of the release button 19 is not cancelled (step S19; NO), the subject tracking unit 77 continues to track the person until the half-pressing of the release button 19 is cancelled, and the imaging condition controlling unit 82 controls the imaging conditions to be optimal for the subject within the tracking frame F2. During the tracking of person, the feature point detection unit 79 detects the feature point of the person's face within the tracking frame F2 at predetermined intervals and the face recognizing unit 80 carries out face recognition based on the detected feature point, that is, the operations in steps S15-S17 are repeated.

After the CPU 75 has determined that the half-pressing of the release button 19 is not cancelled (step S19; NO), the CPU 75 determines whether or not the release button 19 is fully pressed (step S21). If it is determined that the release button 19 is fully pressed (step S21; YES), it is judged that the user has permitted photographing in the current tracking state. Therefore, the imaging condition controlling unit 82 controls the imaging conditions to be optimal for the subject within the tracking frame F2 (step S22), and the CCD 58 carries out actual imaging (step S23).

In contrast, if the face recognition is determined to be unsuccessful in step S17, and the person within the tracking frame F2 is recognized as not being the specified person (step S17; NO), the subject tracking unit 77 stops the tracking of the person (step S27), and the tracking frame F2 displayed on the monitor 18 is hidden by the frame displaying unit 78.

Then, the frame displaying unit 78 displays the fixed frame F1 substantially at the center of the monitor 18 (step S28), and the imaging condition controlling unit 82 controls the imaging conditions to be optimal for the subject within the fixed frame F1 (step S29). Subsequently, the CPU 75 determines whether or not the half-pressing of the release button 19 is cancelled (step S30). If it is determined that the half-pressing is cancelled (step S30; YES), it is judged that the user is not satisfied with photographing under the photographing conditions determined for the subject within the fixed frame F1, and the CPU 75 moves the process to step S5 as shown in FIG. 5A to specify a subject again.

If the CPU 75 determines in step S30 that the half-pressing of the release button 19 is not cancelled (step S30; NO), then, determination is made as to whether or not the release button 19 is fully pressed (step S31). If it is determined that the release button 19 is not fully pressed (step S31; NO), the CPU 75 moves the process to step S29 to repeat the operations in step S29 and the following steps. If the CPU 75 determines in step S31 that the release button 19 is fully pressed (step S31; YES), it is judged that the user has permitted photographing under the imaging conditions determined for the subject within the fixed frame F1. Therefore, the imaging condition controlling unit 82 controls the imaging conditions to be optimal for the subject within the fixed frame F1 (step S22), and the CCD 58 carried out actual imaging (step S23).

As the actual imaging has been carried out in step S23, the image processing unit 64 applies image processing to an actual image obtained through the actual imaging (step S24). At this time, to generate an image file, the actual image data subjected to the image processing may further be compressed by the compression/decompression processing unit 65.

Then, the CPU 75 displays on the monitor 18 the actual image subjected to the image processing, and records the actual image in the external recording medium 70 (step S25). Subsequently, the CPU 75 determines whether or not the power switch 22 has been turned off (step S26). If the power switch 22 has been turned off (step S26; YES), the digital camera 1 is powered off and the process ends. If the power switch 22 is not turned off (step S26; NO), the CPU 75 moves the process to step S1 as shown in FIG. 5A, and repeats the operations in step S1 and the following steps. In this manner, photographing by the digital camera 1 is carried out.

According to the digital camera 1 and the imaging method using the digital camera 1 described above, the user specifies the subject to be tracked before tracking of the subject, and therefore, erroneous detection, as is the case in prior art, can be prevented. Further, the recognition as to whether or not the subject within the tracking frame F2 is the specified subject is repeated while the subject is tracked. This recognition effectively prevents erroneous tracking of a subject similar to the specified subject, and reliable tracking of the specified subject can be achieved. By specifying a desired subject in advance, the desired subject can be reliably tracked even when the subject is moving, and thus the desired subject can be photographed under optimal imaging conditions.

Next, a digital camera 1-2, which is an imaging apparatus according to a second embodiment of the invention, will be described in detail with reference to the drawings. The digital camera 1-2 of this embodiment has substantially the same configuration as that of the digital camera 1 of the previous embodiment, and therefore only a point different from the previous embodiment is described. The difference between the digital camera 1-2 of this embodiment and the digital camera 1 of the previous embodiment lies in that the face recognizing unit 80 also recognizes a feature point around the face of the person surrounded by the tracking frame F2.

Namely, in the digital camera 1-2 of this embodiment, when the subject specifying unit 66 specifies the person's face within the fixed frame F1, the subject specifying unit 66 also specifies another object around the fixed frame F1. Then, the feature point detection unit 79 detects the feature point of the face within the fixed frame F1 as well as a feature point around the fixed frame F1 (such as the shape, a positional relationship with the face or the fixed frame F1), and stores these feature points together in the feature point storing unit 67. Similarly, the feature point of the subject image within the tracking frame F2 and the feature point around the tracking frame F2 are detected, and the face recognizing unit 80 recognizes the face by matching the face within the tracking frame F2 and the feature point around the tracking frame F2 against the face within the fixed frame F1 and the feature point around the fixed frame F1 stored in the feature point storing unit 67.

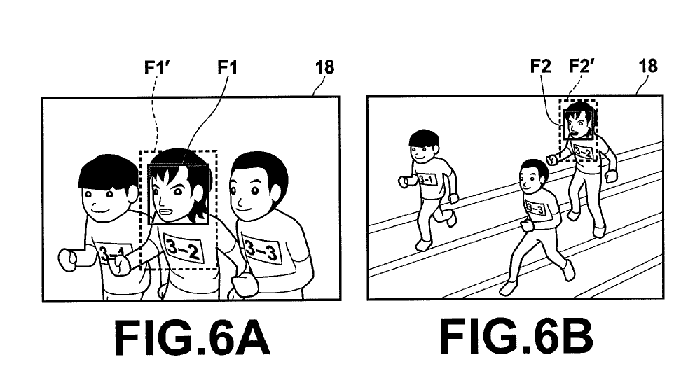

FIGS. 6A and 6B illustrate one example of display on the monitor 18 of the digital camera 1-2 of this embodiment. As shown in FIGS. 6A and 6B, supposing that the situation is a children's sports meet, for example, and every child wears a player's number, it is highly likely that the player's number of a certain child is contained in the image below the face of the child. Therefore, a fixedperipheral frame F1′ and a tracking peripheral frame F2′ (shown in dashed line in the drawings), each having a larger area below the fixed frame F1 or the tracking frame F2 than the area above the fixed frame F1 or the tracking frame F2, are set around the fixed frame F1 and the tracking frame F2, and the feature point detection unit 79 detects the player's number, for example, from the fixed peripheral frame F1′ or the tracking peripheral frame F2′ as a peripheral feature point. When the face recognizing unit 80 recognizes the face of a specified child while the child is tracked, the face recognizing unit 80 also recognizes the player's number. To recognize the number, a commonly-used OCR technique may be used.

It should be noted that, if the player's number is located on a cap or the color of the cap forms the feature, for example, the fixed peripheral frame F1′ and the tracking peripheral frame F2′ may each be shaped to have a larger area above the fixed frame F1 or the tracking frame F2 than the area below the fixed frame F1 or the tracking frame F2. The shape of the fixed peripheral frame F1′ and the tracking peripheral frame F2′ may be changeable by the user through manipulation of the zoom/up-down lever 13, for example. It should be noted that the fixed peripheral frame F1′ and/or tracking peripheral frame F2′ may not be displayed on the monitor 18.

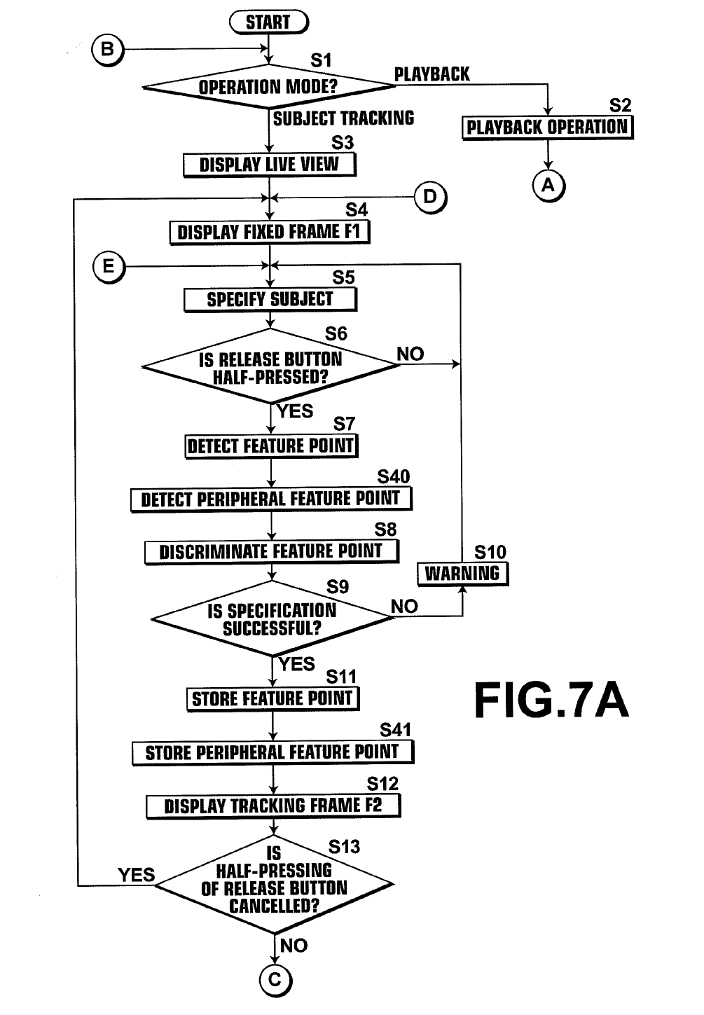

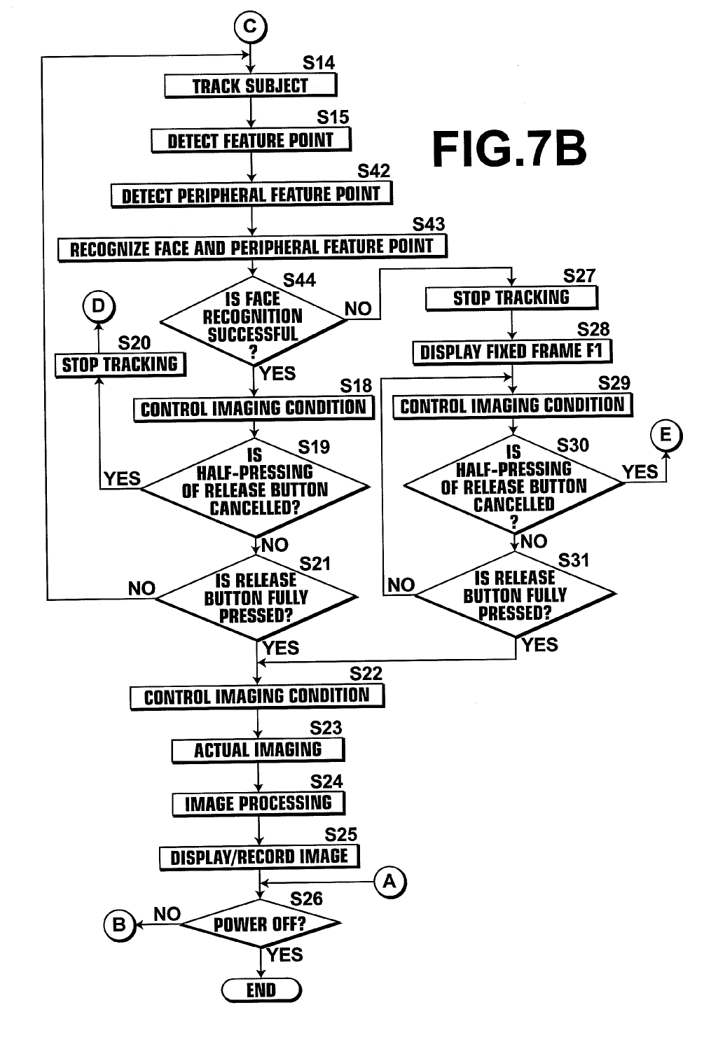

Now, a process carried out during photographing in the digital camera 1-2 having the above-described configuration will be described. FIGS. 7A and 7B are a flowchart illustrating a series of operations carried out in the digital camera 1. It should be noted that the operations in the flowchart of FIGS. 7A and 7B which are the same as those in the flowchart of FIGS. 5A and 5B are designated by the same reference numerals and explanations thereof are omitted.

As shown in FIG. 7A, in the digital camera 1-2 of this embodiment, after the feature point detection unit 79 has detected the feature point of the person's face within the fixed frame F1 (step S7), the feature point detection unit 79 further detects the feature point around the fixed frame F1 from the fixed peripheral frame F1′, i.e., the player's number as shown in FIG. 6A (step S40). Then, if the specification of the subject is successful (step S9; YES), the CPU 75 stores the feature point detected in step S7 in the feature point storing unit 67 (step S11) and also stores the feature point around the fixed frame F1 detected in step S40 in the feature point storing unit 67 (step S41).

While the specified person is tracked by the subject tracking unit 77 in step S12, as shown in FIG. 7B, the feature point detection unit 79 detects the feature point of the face of the person being tracked within the tracking frame F2 at predetermined intervals (step S15), and further detects the feature point around the tracking frame F2, i.e., the player's number, as shown in FIG. 6B, from the tracking peripheral frame F2′ (step S42).

Then, the face recognizing unit 80 matches the feature point of the face detected in step S15 against the feature point of the face stored in the feature point storing unit 67, and matches the player's number detected in step S41 against the player's number stored in the feature point storing unit 67 to recognize whether or not the person within the tracking frame F2 is the person specified in step S5 (step S44).

If the recognition in step S44 is successful (step S44; YES), the CPU 75 moves the process to step S19. If the recognition in step S44 is unsuccessful (step S44; NO), the subject tracking unit 77 stops tracking of the person (step S27), and the CPU 75 moves the process to step S28. In this manner, photographing by the digital camera 1-2 of this embodiment is carried out.

As described above, according to the digital camera 1-2 and the imaging method using the digital camera 1-2 of this embodiment, when the user wants to photograph his or her child as the specified subject among many children and the children wear different player's numbers, for example, the child among many children can be reliably tracked by recognizing the face of the child as well as the player's number worn by the child during tracking. By specifying the face of the subject together with another specifiable feature around the face, the subject recognition can be reliably carried out to prevent erroneous detection, thereby improving accuracy of the tracking.

Next, a digital camera 1-3, which is an imaging apparatus according to a third embodiment of the invention, will be described in detail with respect to the drawings. The digital camera 1-3 of this embodiment has substantially the same configuration as that of the digital camera 1 and the digital camera 1-2 of the previous embodiments, and therefore explanation thereof is omitted.

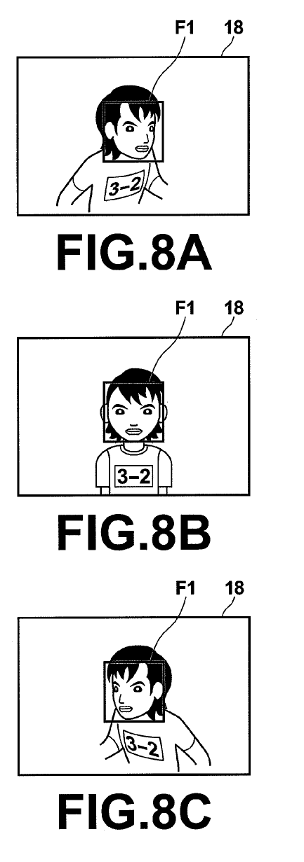

The digital camera 1-3 of this embodiment has a subject specification mode for specifying and registering a person in advance in the digital camera 1 or the digital camera 1-2 of the previous embodiments for the face recognizing unit 80 to carry out the face recognition by based on three-dimensional information. FIGS. 8A to 8C illustrate one example of display on the monitor of the digital camera 1-3. When the subject specification mode is selected, the frame displaying unit 78 displays the fixed frame F1 on the monitor 18, as shown in FIGS. 8A to 8C.

In the digital camera 1-3 of this embodiment, when the user wants to take images of his or her child during a footrace at a sports meet, for example, it is likely to be difficult to photograph the child at the starting line from different angles because of temporal and spatial limitations. Therefore, the user specifies the child as the subject in advance by photographing the child in the subject specification mode of the digital camera 1-3 from the left side as shown in FIG. 8A, from the front side as shown in FIG. 8B, and from the right side as shown in FIG. 8C, with the face of the child being captured within the fixed frame F1, just before going to the sports meet, in front of the house, for example.

Then, the feature point detection unit 79 detects the feature point of the face, such as positions of the eyes, from the respective photographed images. If the detected feature point is accurate enough for the feature-point matching, i.e., the specification of the person is successful, the feature point of the specified person is stored in the feature point storing unit 67 as a three-dimensional feature point.

During the face recognition, this three-dimensional feature point is used to recognize the face. The face recognition using the three-dimensional data may be carried out, for example, by using a technique described in U.S. Pat. No. 7,177,450. By carrying out the face recognition based on the three-dimensional information in this manner, more accurate face recognition can be achieved. It should be noted that, similarly to the digital camera 1-2 of the second embodiment, the peripheral feature point may be recognized in the digital camera 1-3 of this embodiment. In this case, the peripheral feature point is also stored in the feature point storing unit 67 in advance in the subject specification mode.

Although the digital camera 1 of the above-described embodiments carries out the face recognition on a person being tracked, this is not to limit the imaging apparatus of the invention, and the face recognition may not be carried out. In this case, the detection and storing of the feature point are not carried out, i.e., the operations in steps S7 to S11 and steps S15 to S17 of FIG. 5A are not carried out. That is, a subject within the fixed frame F1 is specified as a desired subject when the release button 19 is half-pressed, and the subject specified at this time is kept tracked (step S14 of FIG. 5B). In a case where the subject tracking is carried out by detecting motion vectors, for example, determination may be made as to whether or not motion vectors have gone out of the frame, in stead of the face recognition in steps S16 and S17 of FIG. 5B. If the motion vectors are out of the frame, it is judged that the tracking of the subject is impossible, and the CPU 75 may move the process to step S27. If the motion vectors remain within the frame, the CPU 75 may move the process to step S19.

Although the face of a person is tracked as the subject in the above-described embodiments, this is not to limit the invention. The subject to be tracked may be an animal or a car, for example. The subject in this case must have a feature point that can be used to identify the individual (individual person, individual object).

Further, in the invention, the image processing such as automatic white balance adjustment by the AE/AWB processing unit 63 may be carried out on a live view (motion image) or on an actual image (still image) obtained when the release button 19 is fully pressed, and this can be changed as necessary.

In addition, although the subject is manually specified by the user in the above-described embodiments, this is not to limit the imaging apparatus of the invention. The subject may be specified automatically or semi-automatically by the imaging apparatus. Specifically, in a case where the subject is automatically specified, a desired subject may be registered in advance, for example, and the subject recognition may be carried out based on the registered subject to automatically specify the recognized subject. In a case where the subject is semi-automatically specified, for example, a face of a subject contained in image data may be automatically detected using a known face detection technique, and the user may check the detected face and may specify the face as the subject by pressing a Do button, for example.

The imaging apparatus of the invention is not limited to the digital camera 1 of the above-described embodiments, and may subject to design change, as necessary, without departing from the spirit and scope of the invention.

According to the imaging apparatus and the imaging method of the invention, the user specifies a subject to be tracked before tracking of the subject. Therefore, erroneous detection, as is the case in prior art, can be prevented. Further, whether or not the subject within the tracking frame is the specified subject is repeatedly recognized during the tracking of the subject, and this recognition prevents erroneous tracking of another subject that is similar to the specified subject, thereby achieving reliable tracking of the specified subject. By specifying a desired subject in advance in this manner, the desired subject can be reliably tracked even when the subject is moving, and the desired subject can be photographed under optimal imaging conditions.

What is claimed is:

1. An imaging apparatus comprising:
imaging means for imaging a subject to obtain image data;
display means for displaying the obtained image data;
subject specifying means for specifying the subject in the image data;
tracking frame displaying means for displaying on the display means a tracking frame surrounding the subject specified by the subject specifying means;
subject tracking means for tracking the subject surrounded by the tracking frame;
imaging condition controlling means for controlling an imaging condition for the subject within the tracking frame; and
subject recognizing means for recognizing whether or not the subject within the tracking frame is the subject specified by the subject specifying means,
wherein the subject recognizing means repeats the recognition during the tracking by the subject tracking means.

2. The imaging apparatus as claimed in claim 1, wherein the imaging condition is a setting value of at least one of automatic exposure, automatic focus, automatic white balance and electronic camera shake correction, the setting value being controlled based on the image data of the subject recognized by the subject recognizing means.

3. The imaging apparatus as claimed in claim 1, wherein the imaging means carries out actual imaging, based on the imaging condition, of the subject recognized by the subject recognizing means, and the imaging apparatus further comprising:
image processing means for applying image processing to actual image data obtained through the actual imaging; and
at least one of display controlling means for displaying the actual image data subjected to the image processing by the image processing means on the display means and recording means for recording the actual image data subjected to the image processing by the image processing means in an external recording medium or an internal memory.

4. The imaging apparatus as claimed in claim 2, wherein the imaging means carries out actual imaging, based on the imaging condition, of the subject recognized by the subject recognizing means, and the imaging apparatus further comprising:
image processing means for applying image processing to actual image data obtained through the actual imaging; and
at least one of display controlling means for displaying the actual image data subjected to the image processing by the image processing means on the display means and recording means for recording the actual image data subjected to the image processing by the image processing means in an external recording medium or an internal memory.

5. The imaging apparatus as claimed in claim 3, wherein the image processing comprises at least one of gamma correction, sharpness correction, contrast correction and color correction.

6. The imaging apparatus as claimed in claim 4, wherein the image processing comprises at least one of gamma correction, sharpness correction, contrast correction and color correction.

7. The imaging apparatus as claimed in claim 1 further comprising: imaging instructing means allowing two-step operations thereof including half-pressing and full-pressing; and
fixed frame displaying means for displaying on the display means a fixed frame set in advance in a photographic field,
wherein the subject specifying means specifies a subject within the fixed frame displayed by the fixed frame displaying means when the imaging instructing means is half-pressed.

8. The imaging apparatus as claimed in claim 3 further comprising: imaging instructing means allowing two-step operations thereof including half-pressing and full-pressing; and
fixed frame displaying means for displaying on the display means a fixed frame set in advance in a photographic field,
wherein the subject specifying means specifies a subject within the fixed frame displayed by the fixed frame displaying means when the imaging instructing means is half-pressed.

9. The imaging apparatus as claimed in claim 6 further comprising: imaging instructing means allowing two-step operations thereof including half-pressing and full-pressing; and
fixed frame displaying means for displaying on the display means a fixed frame set in advance in a photographic field,
wherein the subject specifying means specifies a subject within the fixed frame displayed by the fixed frame displaying means when the imaging instructing means is half-pressed.

10. The imaging apparatus as claimed in claim 7, wherein the subject tracking means stops the tracking when the half-pressing of the imaging instructing means is cancelled.

11. The imaging apparatus as claimed in claim 1, wherein the subject recognizing means further recognizes a feature point around the subject surrounded by the tracking frame.

12. The imaging apparatus as claimed in claim 3, wherein the subject recognizing means further recognizes a feature point around the subject surrounded by the tracking frame.

13. The imaging apparatus as claimed in claim 9, wherein the subject recognizing means further recognizes a feature point around the subject surrounded by the tracking frame.

14. The imaging apparatus as claimed in claim 1, further comprising a subject specification mode for specifying and registering a subject in advance by the subject specifying means,
wherein the subject is specified in two or more pieces of image data obtained by imaging the subject from two or more angles, and
the recognition by the subject recognizing means is carried out based on the two or more pieces of image data.

15. The imaging apparatus as claimed in claim 3, further comprising a subject specification mode for specifying and registering a subject in advance by the subject specifying means,
wherein the subject is specified in two or more pieces of image data obtained by imaging the subject from two or more angles, and
the recognition by the subject recognizing means is carried out based on the two or more pieces of image data.

16. The imaging apparatus as claimed in claim 13, further comprising a subject specification mode for specifying and registering a subject in advance by the subject specifying means,
wherein the subject is specified in two or more pieces of image data obtained by imaging the subject from two or more angles, and
the recognition by the subject recognizing means is carried out based on the two or more pieces of image data.

17. An imaging apparatus comprising:
imaging means for imaging a subject to obtain image data;
display means for displaying the obtained image data;
subject specifying means for specifying the subject in the image data;
tracking frame displaying means for displaying on the display means a tracking frame surrounding the subject specified by the subject specifying means;
subject tracking means for tracking the subject surrounded by the tracking frame;
imaging condition controlling means for controlling an imaging condition for the subject within the tracking frame;
imaging instructing means allowing two-step operations thereof including half-pressing and full-pressing; and
fixed frame displaying means for displaying on the display means a fixed frame set in advance in a photographic field,
wherein the subject specifying means specifies the subject within the fixed frame displayed by the fixed frame displaying means when the imaging instructing means is half-pressed.

18. The imaging apparatus as claimed in claim 17, wherein the subject tracking means stops the tracking when the half-pressing of the imaging instructing means is cancelled.

19. An imaging method comprising:
imaging a subject to obtain image data;
displaying the obtained image data on display means;
specifying the subject in the image data;
displaying on the display means a tracking frame surrounding the specified subject;
tracking the subject surrounded by the tracking frame;
controlling an imaging condition for the subject within the tracking frame; and
carrying out imaging based on the controlled imaging condition,
wherein whether or not the subject within the tracking frame is the specified subject is repeatedly recognized during the tracking.

20. An imaging method comprising:
imaging a subject to obtain image data;
displaying the obtained image data on display means;
specifying the subject in the image data;
displaying on the display means a tracking frame surrounding the specified subject;
tracking the subject surrounded by the tracking frame;
repeatedly recognizing during the tracking whether or not the subject within the tracking frame is the specified subject;
controlling an imaging condition for the subject within the tracking frame after the recognition; and
carrying out imaging based on the controlled imaging condition.
